(19) United States
(12) Patent Application Publication
(10) Pub. No.: US 2015/0256799 A1
(43) Pub. Date: Sep. 10, 2015

(54) DISGUISED IP CAMERA SYSTEM

(71) Applicant: Sirchie Acquisition Company, LLC, Youngsville, NC (US)

(72) Inventors: Tony SAGGIOMO, Medford, NJ (US); Joseph HINES, Medford, NJ (US)

(73) Assignee: SIRCHIE ACQUISITION COMPANY, LLC, Youngsville, NC (US)

(21) Appl. No.: 14/636,726

(22) Filed: Mar. 3, 2015

Related U.S. Application Data
(60) Provisional application No. 61/947,790, filed on Mar. 4, 2014.

(51) Int. Cl. H04N 7/18; H04N 5/225; H04N 5/232; G08B 13/196

(52) U.S. Cl. CPC H04N 7/183; G08B 13/19619; H04N 5/2252; H04N 5/23241

(57) ABSTRACT

A remote controlled IP camera system that permits disguise in a tissue box that is configured to house the camera so the camera is remotely controllable over a network. The camera and tissue box permits covert surveillance. The tissue box is configured to house the camera and tissues and may be configured with a band of see through material to permit the camera to view outside the tissue box. The camera is rotatable, focusable, and tiltable remotely,

### CROSS-REFERENCE TO RELATED APPLICATIONS

This application claims benefit and priority to U.S. Patent Application No. 61/947,790, filed Mar. 4, 2014, the disclosure of which is incorporated by reference herein in its entirety.

### BACKGROUND

1.0 Field of the Disclosure

The disclosure is directed generally to an IP camera system and, more particularly, to a system and method for a disguised camera system employing a camouflaged housing component such as, e.g., a tissue box.

2.0 Related Art

Law enforcement agencies, related agencies or individuals are often engaged in surveillance of people of interest or similar situations that require stealth and/or techniques that do not compromise the surveillance operations. Equipment configured to support these types of missions is necessary and new techniques in performing such operations are typically a welcomed addition. In some surveillance operations, the circumstances may dictate at least to some degree the type of equipment that might be employed.

The addition of new surveillance techniques that do not raise easy detection, is flexible to be altered, and at a low cost would contribute to the advancement of law enforcement and related agencies' abilities to achieve their goals.

### SUMMARY OF THE DISCLOSURE

In one aspect, a system for surveillance is provided. The system nay comprise a case configured to house a router and a tissue box configured with a camera therein, the camera configured to be connected to the router, wherein the camera is configured to be controlled by controls received through the router. The camera may be configured to be rotated, zoomed, panned, tilted. The case may include a power source for powering at least one of the camera and the router. The router may comprise a cellular router and may be configured to communicate wirelessly to a remote computer and configured to convey control signals to the camera. The router may be configured to communicate images received from the camera to a remote computer. The camera may be configured to be rotated from 0° to about 360° and configured to be tilted from about −20° through about 90°. The tissue box may be configured with a viewing band configured with small perforations of sufficient density to allow the camera to focus while not allowing the camera to be seen by a casual observer from outside of the tissue box. The tissue box may be configured with a plurality of sides and the viewing band may be configured on the plurality of sides. The plurality of sides with the viewing band may be less than four sides. The case may be further configured to contain a power source for powering the router and the camera. The power source may be a battery and the case may be further configured to store a power charging unit for charging the battery.

In one aspect, a method for surveillance is provided, the method may include the steps of providing a case configured to house a wireless communication device, and providing a tissue box configured with a camera therein, the camera configured to be connected to the commination device, wherein the camera is configured to be controlled by controls received through the wireless commination device. The camera may be configured to be rotated, zoomed, panned, tilted. The step of providing a case may include providing a power source for powering at least one of the camera and the router, wherein the power source is contained within the case.

In one aspect, a tissue box configured to house a camera and one or more tissues is provided, the tissue box may be configured with a viewing band of see through material on one or more sides of the tissue box, the camera may be configured to be remotely controlled and connectable to a router so that video is streamable to a remote location, the camera configured to be rotated, tilted and focused remotely over a communications link. The viewing band may comprise small perforations of sufficient density to allow the camera to focus beyond the viewing band while not allowing the camera or a shape of the camera to be seen by an outside casual observer of the camera module.

### BRIEF DESCRIPTION OF THE DRAWINGS

FIG. 1 is an example illustration of a Tissue Box Disguised IP Camera system, configured according to principles of the disclosure.

FIG. 2 is a close up view of one side of the power and communications case of FIG. 1, configured according to principles of the disclosure.

FIG. 3 is an example side view of a first side of a router of FIG. 1, showing exemplary connectivity, configured according to principles of the disclosure.

FIG. 4 is a side view of a second side of a router of FIG. 1 showing exemplary connectivity, configured according to principles of the disclosure.

FIG. 5 is an illustration of a camera module and an associated camera that is not yet installed in the camera module, according to principles of the disclosure.

FIG. 6 is an illustration of the camera module of FIG. 5, but with the camera installed, configured according to principles of the disclosure.

FIG. 7 is an example illustration showing a power supply compartment and example components therein, configured accruing to principles of the disclosure.

FIG. 8 is a block diagram of an example system, configured according to principles of the disclosure.

### DETAILED DESCRIPTION OF THE DISCLOSURE

The disclosure and the various features and advantageous details thereof are explained more fully with reference to the non-limiting embodiments and examples that are described and/or illustrated in the accompanying drawing and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

A “computer”, as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like.

A “server”, as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any if its computers, may also be used as a workstation.

A “database”, as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “communication link”, as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, WiFi, WiMAX, IEEE 802.11, DECT, 0G, 1G, 2G, 3G or 4G cellular standards, Bluetooth, and the like.

The terms “including”, “comprising” and variations thereof, as used in this disclosure, mean “including, but not limited to”, unless expressly specified otherwise. The term “about” means plus or minus 10%, unless context specifies otherwise.

The terms “a”, “an”, and “the”, as used in this disclosure, means “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium”, as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

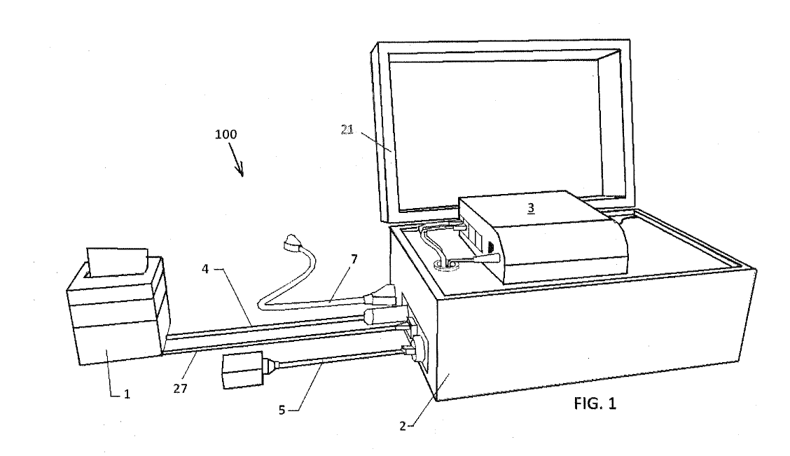

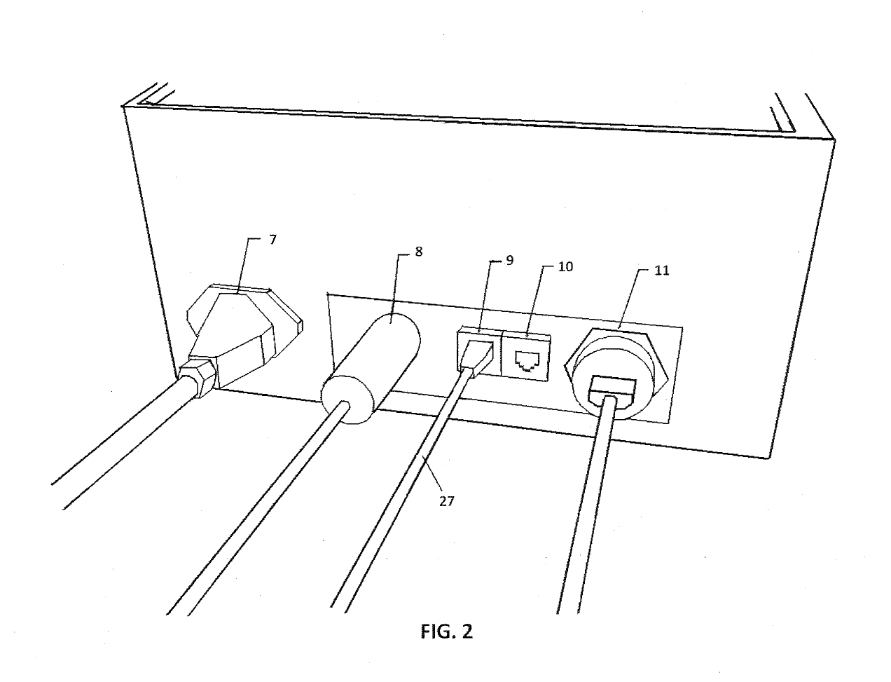

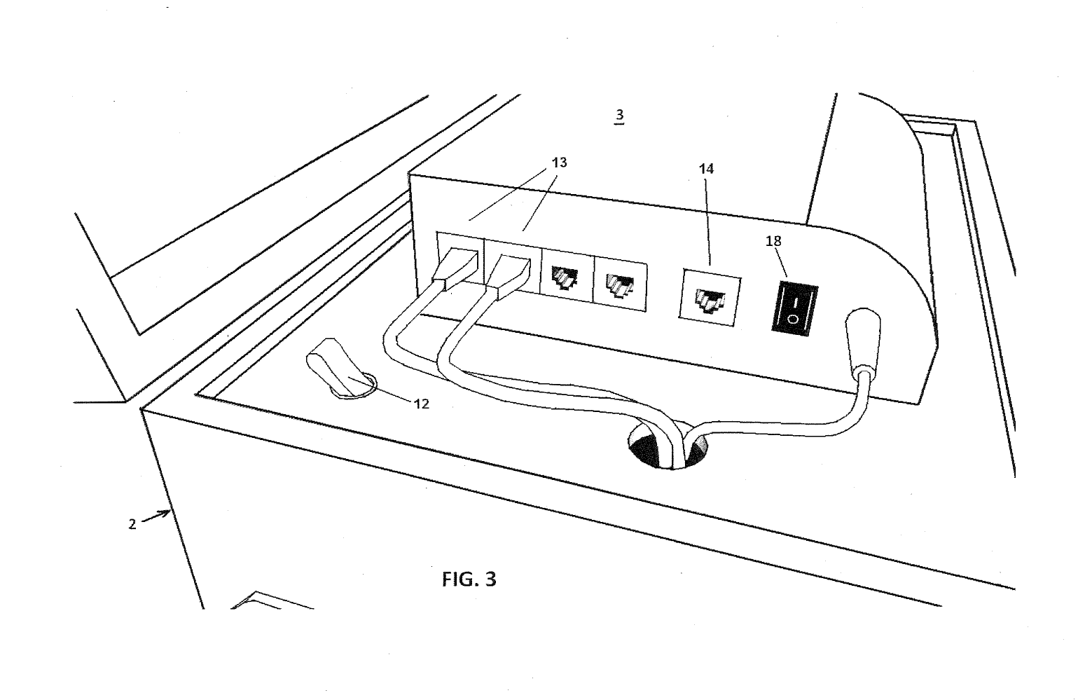

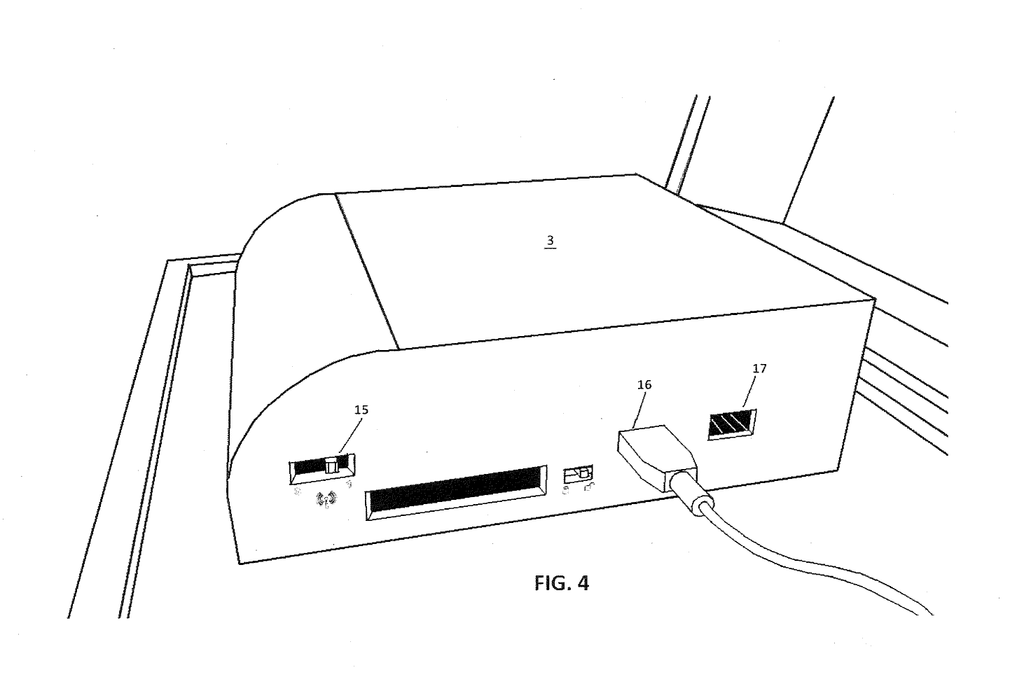

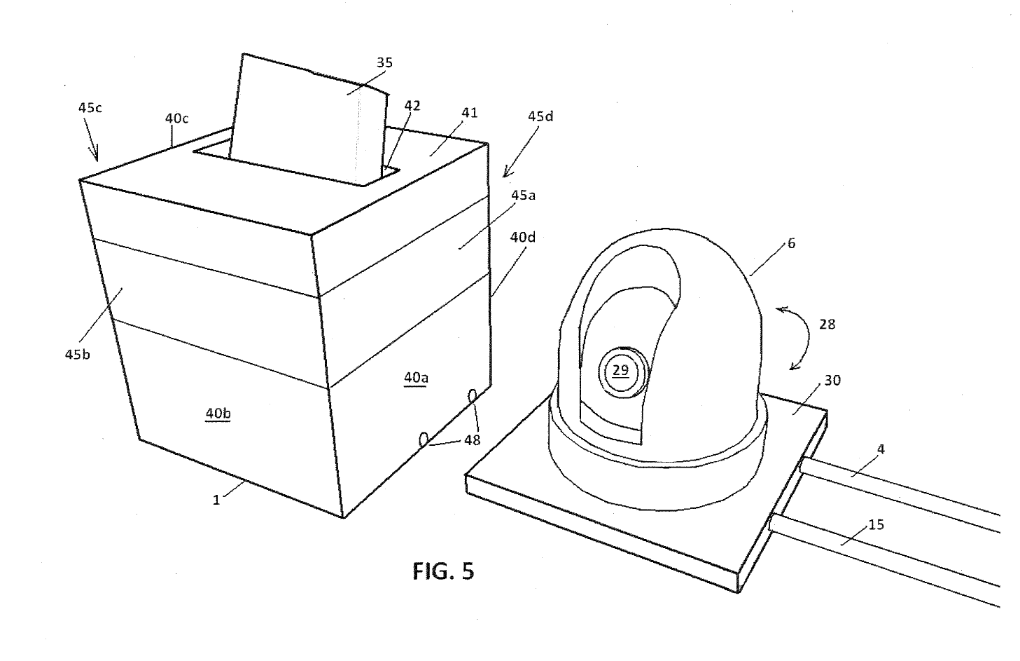

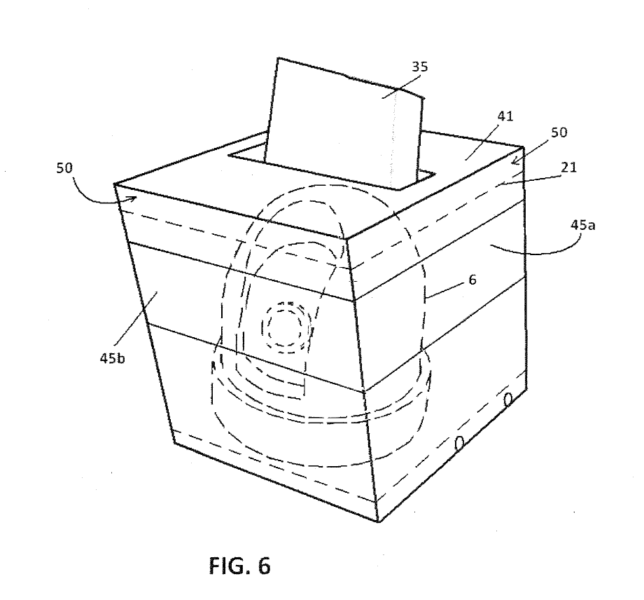

FIG. 1 is an illustration of a Tissue Box Disguised IP Camera system 100, configured according to principles of the disclosure. FIG. 2 is a close up view of one side of the power and communications case of FIG. 1, configured according to principles of the disclosure. FIG. 3 is an example side view of a first side of a router of FIG. 1, showing exemplary connectivity, configured according to principles of the disclosure. FIG. 4 is a side view of a second side of a router of FIG. 1 showing exemplary connectivity, configured according to principles of the disclosure. FIG. 5 is an illustration of a camera module shown in FIG. 1, and an associated camera that is not yet installed in the camera module, according to principles of the disclosure. FIG. 6 is an illustration of the camera module of FIG. 5 but with the camera installed, configured according to principles of the disclosure.

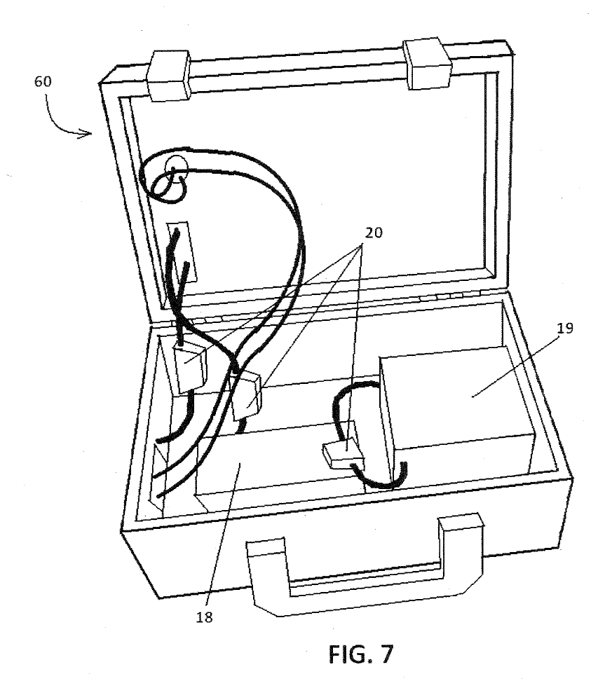

The Tissue Box Disguised IP Camera system 100 may be configured to be used as a self-sufficient, covert “Drop Camera System” for law enforcement agencies (and/or related agencies or individuals) around the world. Since crime activity moves and does not stay in one place, this system may be ideal for mobile applications, in lieu of fixed site or stationary camera surveillance. The system 100 may comprise two primary components: (i) the camera module 1 (or Tissue Box) which may be designed to look like a common tissue box or tissue box decorative cover, or conversely, a tissue box configured with a camera 6, and (ii) a power and communication case 2 containing a power source 19 (FIG. 7) and cellular router 3, and related supporting equipment. The power and communication case 2 may be configured with a cover 21 that opens and closes to gain access to the internal components. These two devices 1 and 2 may be connected by an umbilical cable 4 so the camera 6 (FIG. 5) may draw power from the power supply 19 and communicate with router 3 within a power and communication case 2. The camera module 1 may be rectangular or square in shape, but other shapes are possible. The tissue box (or camera module 1) may be configured to house a camera 6 and one or more tissues 35.

In use, the camera module 1 may be placed in, e.g., a vehicle interior, such as the rear window deck of a car, with the umbilical cable routed down through the interior panels into, e.g., the trunk area where the power and communication case 2 containing the power supply 19 and cellular router 3 can be hidden from view and secured. The cellular router 3 may comprise a wireless communications device for communicating over a communication link such as, e.g., a cellular system.

The power and communication case 2 may be a heavy duty case able to withstand being moved around in a vehicle trunk while protecting the internal components. The case may be secured to the vehicle as necessary. The case may be, e.g., a Pelican 1450NF or equivalent. FIG. 2 is a close up view of one side of the power and communications case 2, configured according to principles of the disclosure.

The cellular router 3 may be configured to accept and communicate via 3G and/or 4G USB type cellular network from major carriers, such as, but not limited to, Verizon, AT&T, and Sprint. Subscriptions to said cellular carriers and modem devices are not ordinarily provided and may be optionally available. Router 3 may be, e.g., Cradlepoint MBR1200B or equivalent. The router 3 may be configured to permit multiple cameras 6 from multiple camera modules 1 or other disguises to be connected, with each camera 6 separately and remotely controllable via the router 3, with views being transmitted across a wireless communication link. A master on/off switch 12 may be configured to turn the entire system 100 on or off. An on/off switch 18 may turn the router 3 on/off. One or a plurality of internal LAN connectors 13 may be replicated on the exterior of the case and two additional ports may be configured within the router case for connecting to two, three or four cameras 6, as a surveillance scenario may require. The router 3 may provide communications for delivering real-time video simultaneously for one, two, three or four cameras 6. Optionally, the router 3 may be configured with an internal WAN connector 14 for connecting to an external network.

An umbilical cable 4 may comprise at least one cat5e communication cable and one shielded twin lead power cable to connect the camera 6 to the router 3, for communications and for power to the camera 6 from a power supply 19. Other types of connectivity may be employed to supply power, and/or communications between the camera 6 and the router 3. For example, a LAN cable 27 may be supported for external LANs for connecting to other LANs. Outer jacketing of the cable may be a black nylon web material to assist in disguise and to protect the internal wires. Length of umbilical cable 4 may be about 9 feet, but may vary.

A power/charging cord 7 may be used to plug the system 100 into a standard 15 amp, 120 Volt AC residential/commercial outlet, or similar source, to charge the internal batteries of power supply 19. The components in power and communication case 2 may be operated while charging. Optional 220 Volt AC power configurations may be provided for international use.

A Wi-Fi defeat switch 15 may be configured to allow users to turn the unit's Wi-Fi signal on or off. An external USB connection cable 5 may be used to replicate a USB connection 11 to the exterior of power and communication case 2.

FIG. 7 is an example illustration showing a power supply compartment and components therein, configured accruing to principles of the disclosure. The power supply compartment 60 may be a portion of the power and communication case 2, such as a lower portion of the power and communication case 2. A battery charger 18 may be, e.g., a 10 amp maximum output battery charger, but may vary as needed. This battery charger 18 may be used to charge the system battery of power supply 19. In one aspect, the battery charger 18 may also be used like a converter to operate the system 100 from a 120 VAC power when the batteries are insufficiently charged or is to be used for extended periods. This may be, e.g., a Noco Genius series charger or equivalent. The power supply 19 may be operationally coupled to router 3 and the camera module 1 and any other electronic components of the Tissue Box Disguised IP Camera system 100.

The power supply 19 may comprise an AGM Battery, or equivalent, and may supply a nominal capacity of, e.g., 18 AH/20 hr rate. This battery may be, e.g., an Odyssey Battery PC635 or equivalent. Battery case may be constructed of 5054 H Series Hardened aluminum sheet metal, 0.093″ thickness and secured by using, e.g., grade 5 cap bolts. Fuses 20 may be located in primary and secondary power paths to prevent damage from short circuits or charging overload.

The camera 6 can peer out from the video transparent center viewing band of the tissue box to capture evidential recordings. Control of the camera pan, tilt and zoom functions, as well as monitoring of the video can be accomplished by multiple users anywhere that internet connectivity is available. This internet connectivity can be from any PC, tablet or smartphone device. The low cost and common-place tissue box disguise provides for reduced attention from suspects or general public and to avoid theft or arouse inducement of theft by a passerby.

The camera 6 configured in camera module 1 may be an auto-focus camera configured to Pan, Tilt, Zoom (PTZ) with about a 0° to 350° Pan and about a −20° through 90° tilt. The camera 6 may be configured to be remotely controlled by a user from a remote location so that the field of view may be changed dynamically using remote controls including focus and pan, tilt, etc. The camera 6 may be configured to communicate over a communications link using Internet Protocol (IP). The camera 6 used may be, e.g., a Panasonic WV-SC385 or equivalent. Vertical field of view with disguise casing 40a-40d in place may be about 45°. Horizontal field of view with disguise in place is about 350°, but in some applications may vary. Usable camera views may be obtained through a first side 40a, a second side 40b, a third side 40c, and/or a fourth side 40d of the camera module 1. The disguise casing may include viewing band 45a, 45b, 45c, 45d of the camera module 1 may be about 0.250″ thick acrylic sheet, or similar material. In some applications, the camera module 1 (tissue box) may be configured with a single side, two sides, three sides, or a plurality of sides having the acrylic sheet, or viewing band 45a, 45b, 45c, 45d, for camera viewing. The viewing band 45a, 45b, 45c, 45d may comprise see-through-material. In some applications, the plurality of sides may be less than four sides. The final overall dimensions of the disguised camera module 1 may be about 7″H×about 5.125″W×about 5.125″D. All corners except possibly the case bottom may be solvent welded. The lower about 3.5″ of the camera module 1 may be covered with an opaque, adhesive backed vinyl material with a decorative pattern. The material may be, e.g., 3M Di-NOC Architectural Finish or equivalent. The upper about 1″ of the casing sides of the disguised camera module 1 (tissue box) and the top may be covered in the same material. The about 2.5″ wide see-through viewing band 45a, 45b, 45c, 45d around the full perimeter of the casing (or, alternatively, only one, only two or only three sides) of the Tissue Box 6, and may be covered with an adhesive backed vinyl material with a perforated pattern. The material forming the band 45a, 45b, 45c, 45d may have a white coloring when viewed from the outside and a black finish when viewed from the inside to prevent undesired reflections from entering the camera 6. The small perforations may be of sufficient density to allow the camera to focus beyond the pattern of the viewing band while not allowing the camera or a shape of the camera to be seen by an outside casual observer of the camera module 1 (i.e., the tissue box). The perforated material may be Avery 1835SA or equivalent.

A tray 21 or shelf may be configured in the top section of the interior of the camera module 1. This tray 21 may be configured as a tissue holder sheet metal tray which may be held in place by spring action of the sheet metal itself. Alternatively, the tray 21 may held in place by fastening technique or connectors along the interior of the camera module 1. The space 50 provided above the tray 21 may hold approximately ½ a quantity of standard pocket tissue pack, but the quantity may vary. This may allow tissues to be used from top of camera module 1, as if it were a traditional or standard tissue box.

The router 3 and camera 6 may be operable communication with a remote server that may assist in the operation and capturing of images/video received from the camera 6. The images/video may be stored to a database for later recall. The images and/or video may be time stamped in real-time.

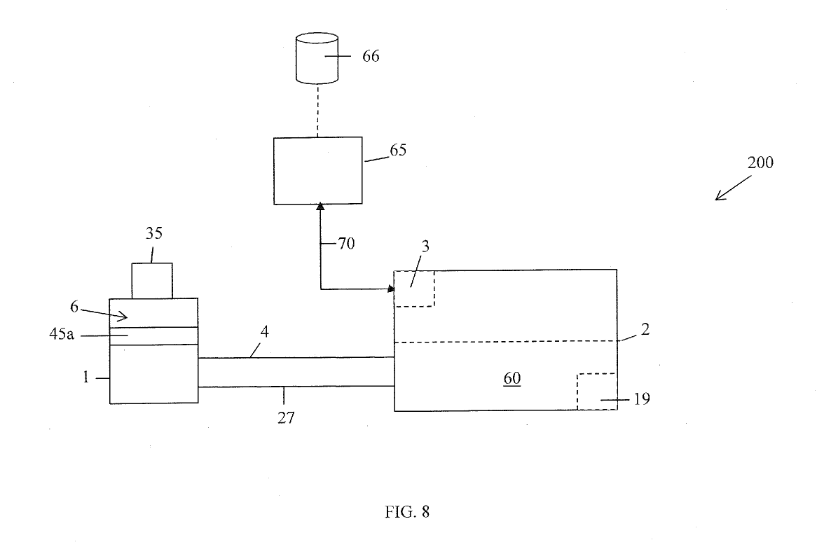

FIG. 8 is a block diagram of an example system, configured according to principles of the disclosure. The system 200 may include the system 100 of FIG. 1, but may include a remote computer 65 which may be a server connected via a communication link 70 to the router 3 of the Tissue Box Disguised IP Camera system 100. The remoter computer 65 may be configured to permit a user to operate the camera 6 remotely including rotating 28, panning, zooming, and tilting of the camera 6. The camera 6 may be configured to be rotated (e.g., from 0 degrees to about 350 degrees), zoomed, panned and/or, tilted. The remote computer 65 may be coupled to a database 66 for storing programming software and/or video imaging data sent by router 3 that may be captured by camera 6 such as, e.g., during a surveillance session. The power and communication case 2 may be configured with a compartment 60 for the power components. The power source 19 may be configured to power at least one of the camera 6 and the router 3.

The system 100 and 200 permits for a portable, self-sufficient, covert “Drop Camera System” for law enforcement agencies (and/or related agencies or individuals) around the world. The system 100 may be easily moved and may be ideal for mobile applications, in lieu of fixed site or stationary camera surveillance. The tissue box (both a tissue box and also a camera module) provides for a tissue box configured to hold typical tissues while also being configured to conceal a camera 6. The camera 6 may be remotely controlled for rotation, focus, pan, tilt, and/or zoom. In this manner, a person operating the system 100 may be concealed and even quite remote from the surveillance site. The camera module 1 may be placed, e.g., in a rear window ledge of a vehicle (or other suitable location in a vehicle) while the power and communication case 2 with its operational and connectivity components (e.g., router 3, power source 19) as described above may be concealed in another part of the vehicle such as, e.g., a trunk area. The tissue box and any tissue 35 provides for a camouflage effect while permitting a person to operate over a communication link 70 the camera 6 configured within the tissue box (i.e., camera module 1). A video stream or images of the surveillance scene may be transmitted over the communication link 70 via router 3 to a remote computer 65 or server. The video or images may be stored (perhaps in database 66, or other storage device, such as a local thumb drive in the case 2 or similar storage device) or viewed as warranted by a particular surveillance situation. The router 3 may be configured to communicate wirelessly to a remote computer 65 and may be configured to convey control signals to the camera. The router 3 may be configured to communicate images received from the camera 6 to a remote computer 65.

While the disclosure has been described in terms of exemplary embodiments, those skilled in the art will recognize that the disclosure can be practiced with modifications in the spirit and scope of the appended claims. These examples are merely illustrative and are not meant to be an exhaustive list of all possible designs, embodiments, applications or modifications of the disclosure.

What is claimed is:

1. A system for surveillance comprising:
a case configured to house a router; and
a tissue box configured with a camera therein, the camera configured to be connected to the router, wherein the camera is configured to be controlled by controls received through the router.

2. The system of claim 1, wherein the camera is configured to be rotated, zoomed, panned, tilted.

3. The system of claim 1, wherein the case includes a power source for powering at least one of the camera and the router.

4. The system of claim 1, wherein the router comprises a cellular router and is configured to communicate wirelessly to a remote computer and configured to convey control signals to the camera.

5. The system of claim 1, wherein the router comprises a cellular router and is configured to communicate images received from the camera to a remote computer.

6. The system of claim 1, wherein the camera is configured to be rotated from 0° to about 360° and configured to be tilted from about −20° through about 90°.

7. The system of claim 1, wherein the tissue box is configured with a viewing band configured with small perforations of sufficient density to allow the camera to focus while not allowing the camera to be seen by a casual observer from outside of the tissue box.

8. The system of claim 7, wherein the tissue box is configured with a plurality of sides and the viewing band is configured on the plurality of sides.

9. The system of claim 8, wherein the plurality of sides is less than four sides.

10. The system of claim 1, wherein the case is further configured to contain a power source for powering the router and the camera.

11. The system of claim 10, wherein the power source is a battery and the case is further configured to store a power charging unit for charging the battery.

12. A method for surveillance, the method comprising the steps of:
providing a case configured to house a wireless communication device; and
providing a tissue box configured with a camera therein, the camera configured to be connected to the commination device, wherein the camera is configured to be controlled by controls received through the wireless commination device.

13. The method of claim 12, wherein the camera is configured to be rotated, zoomed, panned, tilted.

14. The method of claim 12, wherein the step of providing a case includes providing a power source for powering at least one of the camera and the router, wherein the power source is contained within the case.

15. The method of claim 12, wherein the wireless communication device comprises a cellular router and is configured to communicate wirelessly to a remote computer and configured to convey control signals to the camera.

16. The method of claim 12, wherein the wireless communication device comprises a cellular router and is configured to communicate images received from the camera to a remote computer.

17. The method of claim 12, wherein the camera is configured to be rotated from 0° to about 360° and configured to be tilted from about −20° through about 90°.

18. A tissue box configured to house a camera and one or more tissues, the tissue box configured with a viewing band of see through material on one or more sides of the tissue box, the camera configured to be remotely controlled and connectable to a router so that video is streamable to a remote location, the camera configured to be rotated, tilted and focused remotely over a communications link.

19. The tissue box of claim 18, wherein the viewing band comprises small perforations of sufficient density to allow the camera to focus beyond the viewing band while not allowing the camera or a shape of the camera to be seen by an outside casual observer of the camera module.

20. The tissue box of claim 18, wherein the camera is configured to be rotated from 0° to about 350° and configured to be tilted from about −20° through about 90°.
